(19) United States
(12) Patent Application Publication
(10) Pub. No.: US 2020/0290175 A1
(43) Pub. Date: Sep. 17, 2020

(54) SECURE GRIPPER FOR MOVING APPLIANCES

(71) Applicant: Franklin Farrar, Macon, GA (US)

(72) Inventor: Franklin Farrar, Macon, GA (US)

(21) Appl. No.: 16/352,789

(22) Filed: Mar. 13, 2019

(51) Int. Cl. B25B 9/00

(52) U.S. Cl. CPC B25B 9/00

(57) ABSTRACT

A device to help ease the moving of large appliances, furniture and other white goods is presented. The device allows easy gripping by a user or users. The device has an adjustable length belt with a connector and a receiving end. The connector end is coupled into the receiver in a secure manner. The belt is adjusted using an adjustable coupling which is used to make the belt taut around an appliance or to allow slack into the belt when the belt is placed around the appliance or is to be removed from the appliance. The belt also has a plurality of handles which may be adjusted to any position along the belt. The handles provide a secure and steady grip for the users.

### FIELD OF THE INVENTION

This invention relates to harness belts and more specifically to a harness belt with a handle to move appliances.

### BACKGROUND

Anyone who has moved white goods or a large piece of furniture without hand holds can probably attest to how much safer and easier it would be with conveniently placed handles, especially when stairs are involved. Many technologies have been solicited to assist in this process.

Some inventions can easily be employed but lack in stability and safety. These types of straps are great for lifting but do not attached themselves directly to the object being moved and therefore can be unsafe to manipulate on stairs or other uneven terrain. Some have good stability and safety features but require excessive installation time and become inconvenient for the end user which requires tools and screws to install.

In addition, tarping these objects using these aforementioned devices becomes cumbersome when waterproofing is required as there is no convenient way to keep the tarp in place. Much of the prior art is both safe and convenient but lack multi-functional flexibility such as those designed for water heaters, crib mattresses and frame transportation.

A device is needed that is both ergonomical and easy to install yet can be safely secured to the object to be moved. The intention of the present invention is to overcome some of the shortcomings of the aforementioned prior art by seeking to make the moving and lifting task both convenient through simple installation and safe, through semi-permanent attachment of the object being moved.

### BRIEF DESCRIPTION OF THE DRAWINGS

FIG. 1 is a view of an exemplary gripper belt for moving appliances.

FIG. 2 is an example of the use of the exemplary gripper belt.

### DETAILED DESCRIPTION

Reference will now be made in detail to the present preferred embodiments, examples of which are illustrated in the accompanying drawings. All terms in the plural shall also be taken as singular and vice-versa. Further, any reference to he shall also be applicable to she and vice-versa.

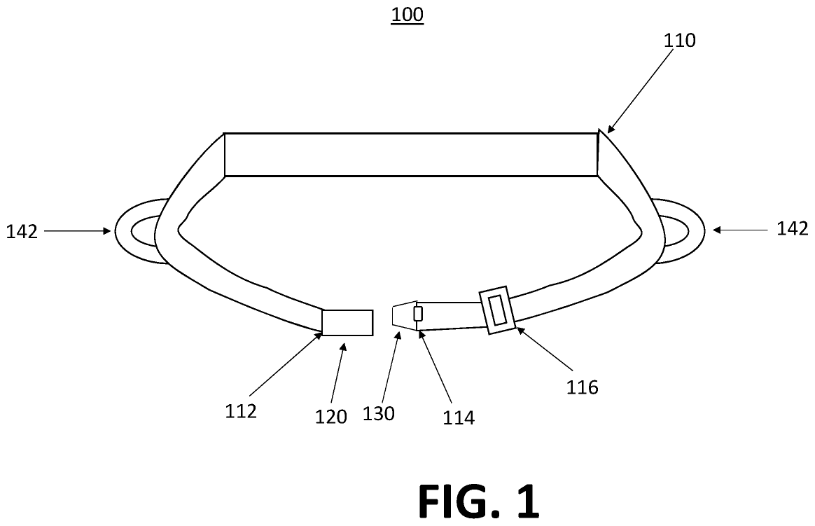

Referring to FIG. 1, an exemplary gripper device 100 is shown. The gripper device 100 is useful for moving large appliances, such as a refrigerator, washing machine, dryer, stove, dishwasher, etc. The gripper device 100 may also be useful for moving furniture such as dressers, couches, etc.

The gripper device 100 has a belt 110. The belt 110 is preferably made of a strong material such as nylon, polyester, cotton blends, etc. The belt 110 should also be elastic and be able to be form fitted to the appliance that requires a gripper device 100.

The belt 110 may be adjustable. The belt 110 may have an adjustable coupling 116 which is useful in adjusting the length of the gripper device 100 when securely fitting the gripper device 100 around an appliance, other white good, furniture, etc. The adjustable coupling 116 is also useful in releasing the tautness of the belt 110 such that the gripper device 100 may be extended to fit around an appliance or to be removed from the appliance after moving the appliance.

The belt 110 of the gripper device 100 has a first end 112 and a second end 114. A receiver end 120 is coupled to the first end 112 of the belt 110. The receiver end 120 is useful for receiving a coupling from the second end 114 of the belt 110. The receiver end 120 may be made of a strong material, such as metal, hard plastic, Velcro, or be holes substantially near the second end 114 of the belt 110.

The second end 114 of the belt 110 is coupled to a connector end 130. The connector end 130 may be made of a strong material such as metal, hard plastic, Velcro.

The connector end 130 coupled to the second end 114 of the belt 110 may be a hook, a buckle, a Velcro end, an adjustable closure, etc. The type of connector end 130 coupled to the second end 114 of the belt 110 must be compatible with the receiver end 120 coupled to the first end 112 of the belt 110.

The belt 110 of the gripper device 100 may also have a plurality of handles 140, 142. The plurality of handles 140, 142 may be made of a hard, durable material, such as metal, hard plastic, formed plastic, nylon, etc. The handles 140, 142 are useful for providing a gripping position for a person moving an appliance, white good, furniture, etc.

The plurality of handles 140, 142 may be positioned anywhere along the belt 110. For example, the handles 140, 142 are placed in the example 180 degrees from each other, but the plurality of handles may be offset, may be evenly spaced, etc. The plurality of handles 140, 142 may be positioned to be on the side of the appliance to be moved or may be placed to align to the back and/or front of the appliance to be moved, etc.

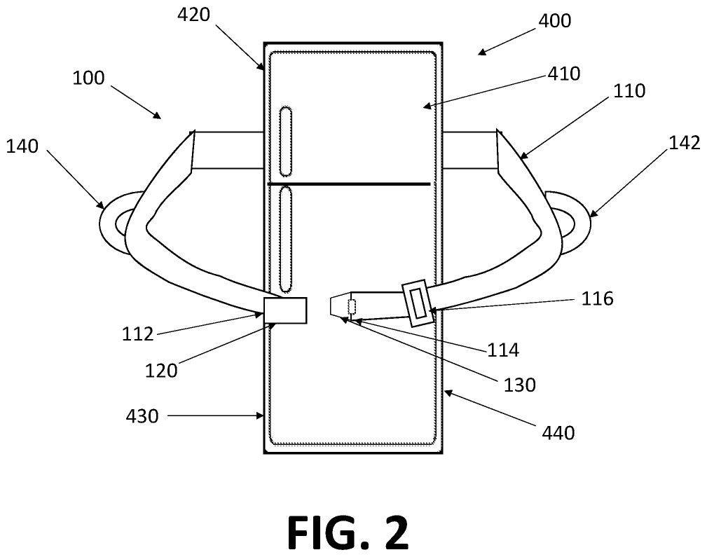

Moving now to FIG. 2, an example use of the gripper device 100 of FIG. 1 is shown. The gripper device 100 is to be used to move a refrigerator 400 up stairs in an attempt to reposition the location of the refrigerator.

The refrigerator 400 has a front side 410, a rear side 420, a first side 430 and a second side 440.

The belt 100 is first adjusted to fit around the refrigerator 400 by placing more slack in the belt utilizing the adjustable coupling 116. The gripper device 100 is then placed around the refrigerator 400.

Once the gripper device 100 is placed around the refrigerator. The receiver 120 coupled to the first end 112 of the belt 100 is placed to receive the connector 130 coupled to the second end 114 of the belt 110.

The connector 130 coupled to the second end 114 of the belt 110 is the coupled to the receiver 120 coupled to the first end 112 of the belt 110. The handles 140, 142 are shown and positioned on the first side 430 and the second side 440 for the users to have easy access to the handles 140, 142.

The belt 110 may have a pad or blanket to help avoid damage to the appliance and it may be placed in several places such as between the belt 110 and the rear side 420 of the refrigerator 400, the belt 110 and the front side 410 of the refrigerator, or on any side or corner of the refrigerator 400.

The user would then adjust the length of the gripper device 100 by shortening the belt 110 by adjusting the adjustable coupling 116, removing the slack and making the belt 110 fit snuggly around the refrigerator 400.

The user or users, usually at least two people would work together to move an appliance such as a refrigerator, use the handles 140, 142, to pick up the refrigerator 400 and move up the stairs.

One user would use handle 140 on the first side 430 of the refrigerator and a second user would use handle 142 on the second side 440 of the refrigerator. Thus, trying to balance the weight of the refrigerator 400 to help in moving the refrigerator 400.

Once the refrigerator 400 is moved up the stairs and set into the desire location, the adjustable coupling 116 is adjusted to add slack into the belt 110. The connector 130 is then uncoupled from the receiver 120 and the gripper device 100 is removed from around the refrigerator 400.

The features described with respect to one embodiment may be applied to other embodiments or combined with or interchanged with the features of other embodiments, as appropriate, without departing from the scope of the present invention.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

1. An apparatus for moving a large appliance, said apparatus comprising:
a belt having a first end and a second end and configured to be form-fitted to said large appliance;
a receiver end, said receiver end being coupled to said first end of said belt and configured to receive a coupling from said second end of said belt;
a connector end, said connector end being coupled to said second end of said belt;
an adjustable coupling, said adjustable coupling coupled to said belt and configured to adjust the length of said apparatus when securely fitting said apparatus around said large appliance;
a plurality of handles, said plurality of handles located on said belt and configured to provide a gripping position for a user, wherein each of the plurality of handles being placed one-hundred eighty degrees (180°) from another of the plurality of handles.

2. The apparatus of claim 1, wherein said belt is made of a strong material.

3. The apparatus of claim 2, wherein said strong material is selected from the group consisting of nylon, polyester, and cotton blends.

4. The apparatus of claim 1, wherein said belt is adjustable.

5. The apparatus of claim 1, wherein said receiver end is made of a material selected from the group consisting of metal and hard plastic.

6. The apparatus of claim 1, wherein said connector end is made of a strong material.

7. The apparatus of claim 1, wherein said connector end is selected from the group consisting of a hook, a buckle, and an adjustable closure.

8. The apparatus of claim 1, wherein said receiver end is compatible with said connector end.

9. The apparatus of claim 1, wherein said plurality of handles is made of a material selected from metal, hard plastic, formed plastic, and nylon.

10. The apparatus of claim 1, wherein said plurality of handles is placed at 180 degrees from each other.

11. The apparatus of claim 1, wherein said plurality of handles is placed in an off-set position from each other.

12. The apparatus of claim 1, wherein said plurality of handles is evenly spaced from each other.
